(19) United States
(12) Patent Application Publication
(10) Pub. No.: US 2013/0245916 A1
(43) Pub. Date: Sep. 19, 2013

(54) Engine Control Unit and Atmospheric Pressure Estimation Method

(71) Applicant: HITACHI AUTOMOTIVE SYSTEMS, LTD., Hitachinaka-shi (JP)

(72) Inventor: Yoshikuni KURASHIMA, Isesaki-shi (JP)

(73) Assignee: HITACHI AUTOMOTIVE SYSTEMS, LTD., Hitachinaka-shi (JP)

(21) Appl. No.: 13/826,916

(22) Filed: Mar. 14, 2013

(30) Foreign Application Priority Data
Mar. 15, 2012 (JP) 2012-058594

(51) Int. Cl. F02D 45/00

(52) U.S. Cl. CPC F02D 45/00
USPC 701/102

(57) ABSTRACT

When the opening of a throttle valve provided in an intake system of an engine with a supercharger is substantially fully opened, an electronic control unit estimates atmospheric pressure based on intake air pressure in the downstream of the throttle valve at the time of start of supercharging by the supercharger. Here, the meaning that the opening of the throttle valve is substantially fully opened includes such a state that the opening becomes equal to or greater than a predetermined opening and hence is considered to be approximately fully opened, as well as the state that the opening of the throttle valve is 100% (full throttle).

### BACKGROUND OF THE INVENTION

1. Field of the Invention

The present invention relates to an engine control unit and an atmospheric pressure estimation method.

2. Description of Related Art

In a vehicle running on a mountain road or the like, engine control is performed to correct the amount of fuel injection and the like according to the atmospheric pressure because the air density varies with the altitude. Therefore, as described in Japanese Laid-Open (Kokai) Patent Application Publication No. 2005-36733, there is proposed a technique for estimating atmospheric pressure based on a ratio between target supercharging pressure and intake air pressure in a steady state of an engine with a supercharger after being supercharged by substantially fully opening the throttle opening.

However, in an engine with a turbocharger as the supercharger, since the intake air pressure converges on the target supercharging pressure as a result of supercharging pressure control, the ratio between the target supercharging pressure and the intake air pressure approaches 1, failing to secure the estimation accuracy of the atmospheric pressure.

### SUMMARY OF THE INVENTION

When the opening of a throttle valve provided in an intake system of an engine with a supercharger is substantially fully opened, an electronic control unit estimates atmospheric pressure based on intake air pressure in the downstream of the throttle valve at the time of start of supercharging by the supercharger. Here, the meaning that the opening of the throttle valve is substantially fully opened includes such a state in which the opening becomes equal to or greater than a predetermined opening and hence is considered to be approximately fully opened, as well as the state that the opening of the throttle valve is 100% (full throttle).

Other objects and features of aspects of this invention will be understood from the following description with reference to the accompanying drawings.

### BRIEF DESCRIPTION OF THE DRAWINGS

FIG. 1 is a schematic view of a vehicle engine system.

FIG. 2 is a flowchart for describing a first example of atmospheric pressure estimation processing.

FIG. 3 is an explanatory view of a correlation among throttle opening, intake air pressure, and engine speed in a non-supercharged steady state.

FIG. 4 is an explanatory view of a map used for determining a period of calculating an average value of atmospheric pressure.

FIG. 5 is a time chart for describing temporal variations in throttle opening and intake air pressure in the first example of atmospheric pressure estimation processing.

FIG. 6 is a flowchart for describing a second example of atmospheric pressure estimation processing.

FIG. 7 is a flowchart for describing a third example of atmospheric pressure estimation processing.

FIG. 8 is an explanatory view of a correlation among intake air flow, engine speed, and intake air pressure.

FIG. 9 is a flowchart for describing a fourth example of atmospheric pressure estimation processing.

FIG. 10 is a time chart for describing temporal variations in throttle opening, intake air pressure, and intake air flow in the fourth example of atmospheric pressure estimation processing.

FIG. 11 is a flowchart for describing a fifth example of atmospheric pressure estimation processing.

FIG. 12 is a time chart for describing temporal variations in throttle opening, intake air pressure, and intake air flow in the fifth example of atmospheric pressure estimation processing.

### DESCRIPTION OF THE EMBODIMENTS

An embodiment for carrying out the present invention will now be described in detail with reference to the accompanying drawings.

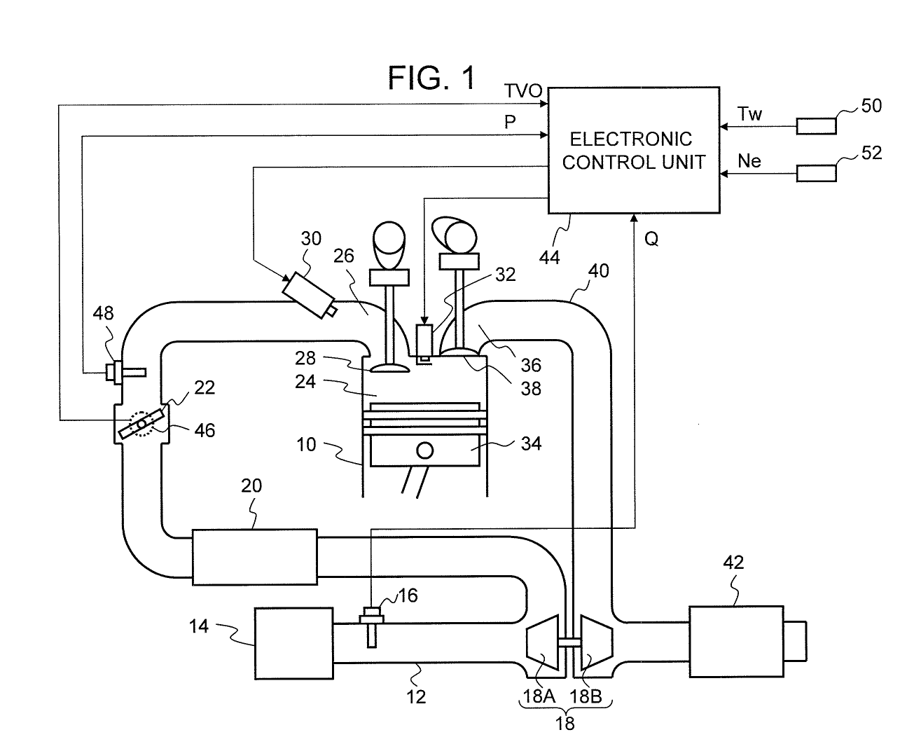

FIG. 1 illustrates the structure of a vehicle engine system equipped with an engine control unit according to the embodiment.

An engine 10 is, for example, an in-line four-cylinder gasoline engine, in which an intake air flow sensor 16 for detecting an intake air flow Q of intake air passing through an air cleaner 14, which is an example of a load on engine 10, is fitted into an intake pipe 12 (intake system) for introducing intake air into each cylinder. As intake air flow sensor 16, for example, a hot-wire flowmeter such as an air flowmeter can be used. Note that the load on engine 10 is not limited to intake air flow Q, and a known state quantity closely associated with torque, such as intake air pressure or accelerator opening, can be used.

In intake pipe 12 located in the air intake downstream of intake air flow sensor 16, a compressor 18A of a turbocharger 18 as an example of the supercharger, an intercooler 20 for cooling intake air passing through turbocharger 18, and a throttle valve 22 opened and closed in conjunction with an accelerator pedal (not shown) are arranged in this order along the direction of circulation of intake air. Turbocharger 18 is not limited to a commonly-used turbocharger, and any other one of various turbochargers such as a variable nozzle turbocharger and a twin-scroll turbocharger can be used. Intercooler 20 may be of either an air-cooling type using running air flow or the like or of a water-cooling type using engine coolant or the like. Throttle valve 22 is not limited to a mechanical type opened and closed by mechanically linking with the accelerator pedal, and it may be of an electronically-controlled type opened and closed electrically according to the opening of the accelerator pedal. Note that throttle valve 22 illustrated is in a substantially fully-closed state. When the mechanical type of throttle valve 22 is employed, a bypass passage with an idle control valve therein is also provided to run idle.

An intake valve 28 is provided in an intake port 26 for introducing intake air into a combustion chamber 24 of each cylinder to open and close the opening of intake port 26. A fuel injector 30 for injecting fuel toward intake port 26 is fitted in a portion of intake pipe 12 located in the air intake upstream of intake valve 28, specifically a portion of intake pipe 12 located between throttle valve 22 and intake valve 28. Fuel injector 30 is an electromagnetic fuel injector, which injects fuel when a magnetic attractive force is generated by energization of a magnet coil to lift a valve biased by a spring in a valve closing direction to thereby open the valve. Fuel with pressure regulated to predetermined pressure is supplied to fuel injector 30 so that an amount of fuel proportional to the valve opening time will be injected.

Fuel injected from fuel injector 30 is introduced into combustion chamber 24 through a gap between intake port 26 and intake valve 28 together with intake air, and ignited and burned by spark ignition of a spark plug 32. The pressure exerted by the burning pushes a piston 34 down toward a crankshaft (not illustrated) to drive the crankshaft to rotate.

Furthermore, an exhaust valve 38 is provided in an exhaust port 36 for discharging exhaust gas from combustion chamber 24 to open and close the exhaust port. When exhaust valve 38 is opened, exhaust gas is exhausted into an exhaust pipe 40 through a gap between exhaust port 36 and exhaust valve 38. In exhaust pipe 40, a turbine 18B of turbocharger 18 and a catalytic converter 42 are arranged in this order along the direction of circulation of exhaust gas. The energy of exhaust gas flowing through exhaust pipe 40 drives turbine 18B of turbocharger 18 to rotate, so that compressor 18A of turbocharger 18 provided in intake pipe 12 is rotated. Catalytic converter 42 is a device for purifying harmful substances in the exhaust gas to change them to harmless components. For example, catalytic converter 42 is composed of three-way catalysts for purifying CO (carbon monoxide), HC (hydrocarbon), and NOx (nitrogen oxide) in the exhaust gas at the same time.

Fuel injector 30 and spark plug 32 are controlled by an electronic control unit 44 with a built-in microcomputer (processor). Electronic control unit 44 inputs signals from various sensors and the like to determine each operation amount of fuel injector 30 and spark plug 32 to be output, according to a prestored control program. In fuel injection control using fuel injector 30, for example, fuel is injected individually in time with an intake stroke of each cylinder. This is so-called “sequential injection control.”

Input to electronic control unit 44 in addition to a signal from intake air flow sensor 16 are signals respectively from an opening sensor 46 for detecting the opening (throttle opening) TVO of throttle valve 22, an intake air pressure sensor 48 for detecting an intake air pressure P (absolute pressure) in the air intake downstream of throttle valve 22, a water temperature sensor 50 for detecting a coolant temperature (water temperature) Tw of engine 10, and an engine speed sensor 52 for detecting an engine speed Ne of engine 10. Note that intake air flow Q, throttle opening TVO, intake air pressure P, water temperature Tw, and engine speed Ne may also be read from another electronic control unit connected through an in-car network such as CAN (Controller Area Network) instead of being read from the respective sensors.

Electronic control unit 44 controls fuel injector 30 and spark plug 32 as follows, that is, electronic control unit 44 reads intake air flow Q and engine speed Ne from intake air flow sensor 16 and engine speed sensor 52, respectively, to calculate a basic amount of fuel injection according to the engine operating conditions based on intake air flow Q and engine speed Ne. Furthermore, electronic control unit 44 reads not only intake air pressure P from intake air pressure sensor 48 to estimate atmospheric pressure in processing to be described later, but also water temperature Tw from water temperature sensor 50 to calculate an amount of fuel injection obtained by correcting the basic amount of fuel injection by atmospheric pressure, water temperature Tw, and the like. Then, electronic control unit 44 injects fuel corresponding to the amount of fuel injection from fuel injector 30 at timing according to the engine operating conditions to actuate spark plug 32 accordingly to ignite and burn a mixture of fuel and intake air. At this time, electronic control unit 44 reads an air-fuel ratio from an unillustrated air-fuel ratio sensor to perform feedback control on fuel injector 30 so that the air-fuel ratio in the exhaust gas approximates a theoretical air-fuel ratio.

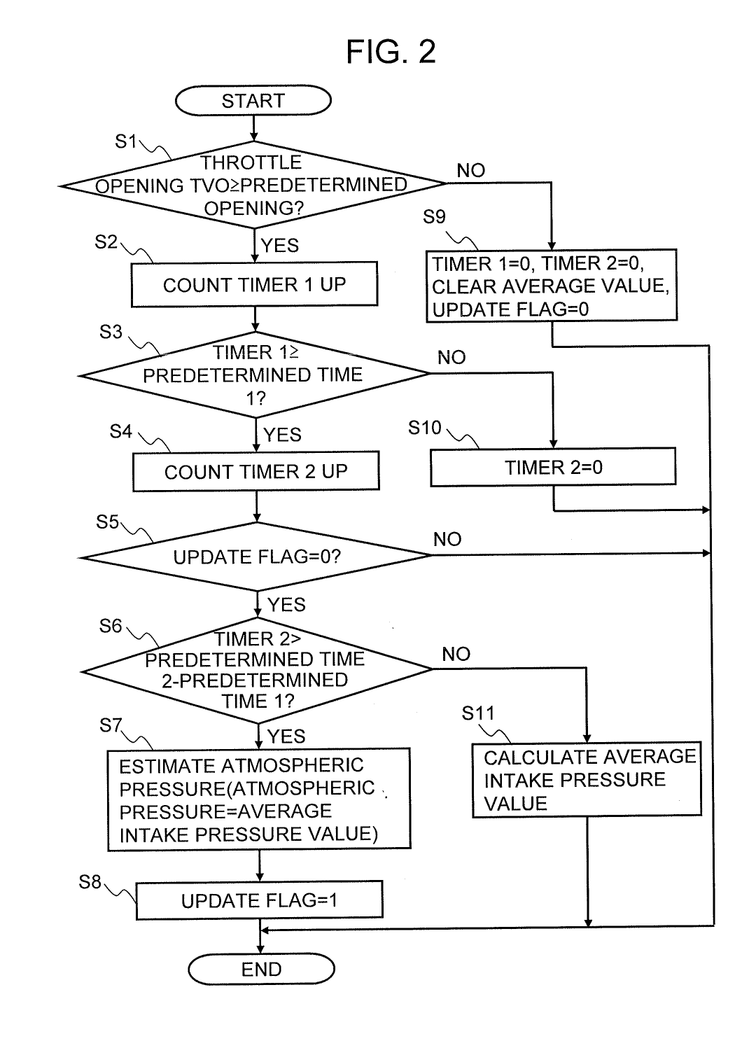

FIG. 2 illustrates a first example of atmospheric pressure estimation processing to be performed by electronic control unit 44 repeatedly at every predetermined time Δt after the start of electronic control unit 44.

In step 1 (abbreviated as “S1” in FIG. 2; the same will apply hereinafter), electronic control unit 44 reads throttle opening TVO from opening sensor 46 to determine whether this is equal to or greater than a predetermined opening. Here, the predetermined opening is a threshold for determining whether the throttle opening is substantially fully opened, including an opening regarded as being approximately fully opened as well as 100% at which the throttle opening is fully opened. Then, when electronic control unit 44 determines that throttle opening TVO is equal to or greater than the predetermined opening, the procedure proceeds to step 2 (Yes). On the other hand, when electronic control unit 44 determines that throttle opening TVO is less than the predetermined opening, the procedure proceeds to step 9 (No) to reset the counts of timer 1 and timer 2 to 0, respectively, clear the average intake air pressure value to 0, and reset the update flag to 0 as will be described in detail later.

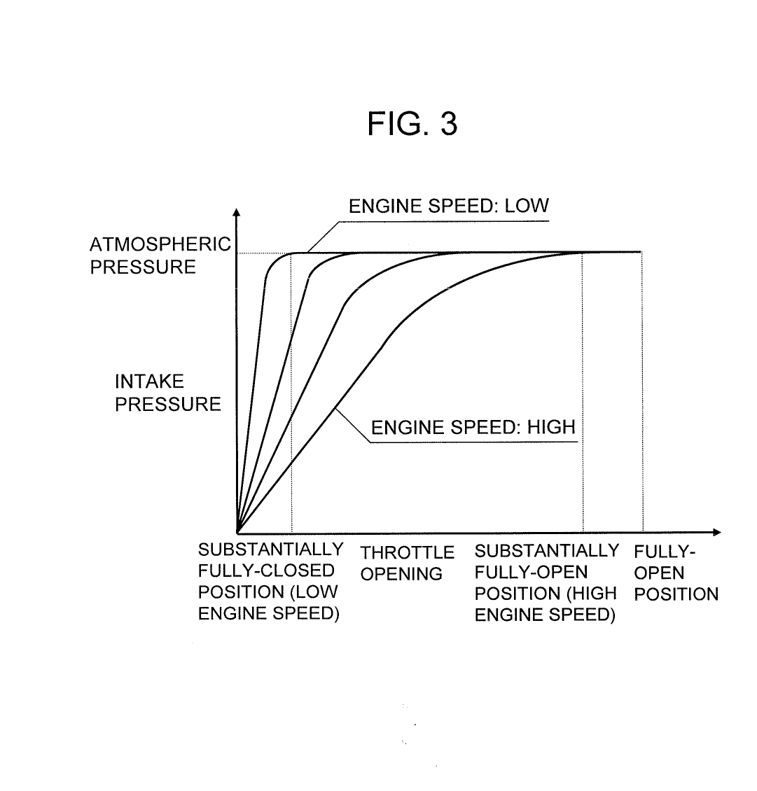

The predetermined opening may be changed according to the engine speed. In other words, intake air pressure exhibits the characteristics as illustrated in FIG. 3 with respect to throttle opening in a steady state of no supercharging by turbocharger 18. When the engine speed is low, the intake air pressure becomes atmospheric pressure in a position where the throttle opening is small. On the other hand, when the engine speed is high, the intake air pressure becomes the atmospheric pressure in a position where the throttle opening is large. This results from a balance between the intake air flow passing through throttle valve 22 and the intake air flow introduced into combustion chamber 24. Such a state that the throttle opening is substantially fully opened is throttle opening in a range where the intake air pressure becomes atmospheric pressure. Such a substantially fully-open position can be predetermined by matching or simulation, so that the predetermined opening according to the engine speed can be set in a map to make a calculation.

In step 2, electronic control unit 44 counts timer 1 up, i.e., the duration of the substantially fully-open state in which throttle opening TVO is equal to or greater than the predetermined opening is moved forward by a predetermined time Δt.

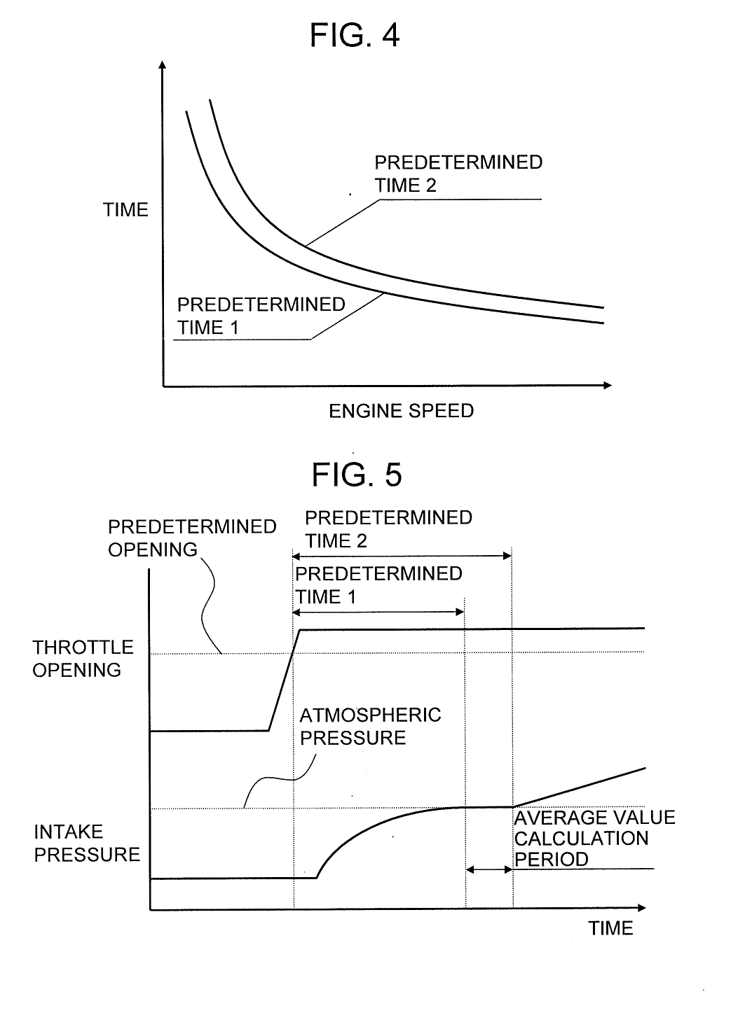

In step 3, electronic control unit 44 determines whether the duration of the substantially full-open state, obtained by multiplying the count of timer 1 by predetermined time Δt, is equal to or greater than a predetermined time 1. Here, predetermined time 1 is a threshold for determining whether intake air pressure in the downstream of throttle valve 22 rises up to around the atmospheric pressure after throttle opening TVO is substantially fully opened, exhibiting such characteristics that nonlinearly decreases as the engine speed increases as illustrated in FIG. 4. This is because intake pipe 12 and an intake collector (not illustrated) exist downstream of throttle valve 22 to cause a time lag after intake air is filled therein until intake air pressure rises. Electronic control unit 44 reads engine speed Ne from engine speed sensor 52 and refers to a map in which the characteristics illustrated in FIG. 4 are set to determine predetermined time 1 according to engine speed Ne. Then, when electronic control unit 44 determines that the duration of throttle opening TVO in the substantially fully-open state is equal to or greater than predetermined time 1, the procedure proceeds to step 4 (Yes). On the other hand, when electronic control unit 44 determines that the duration of throttle opening TVO in the substantially fully-open state is less than predetermined time 1, the procedure proceeds to step 10 (No) to reset, to 0, the count of timer 2 for timekeeping of a period of calculating an average value of intake air pressure in the downstream of throttle valve 22 (average value calculation period).

In step 4, electronic control unit 44 counts timer 2 up, i.e., it moves the average value calculation period forward by a predetermined time Δt.

In step 5, electronic control unit 44 determines whether an update flag indicating whether atmospheric pressure is estimated when throttle opening TVO is substantially fully opened is 0 (indicating that atmospheric pressure is not estimated). Then, when electronic control unit 44 determines that the update flag is 0, the procedure proceeds to step 6 (Yes), while when it determines that the update flag is 1, the processing is ended (No).

In step 6, electronic control unit 44 determines whether the average value calculation period, obtained by multiplying the count of timer 2 by predetermined time Δt, is greater than a value obtained by subtracting predetermined time 1 from a predetermined time 2. Here, predetermined time 2 is a threshold for determining whether intake air pressure in the downstream of throttle valve 22 becomes higher than the atmospheric pressure due to supercharging after throttle opening TVO becomes substantially fully opened, exhibiting such characteristics that nonlinearly decreases as the engine speed increases as illustrated in FIG. 4. This is because the rotation speed of turbine 18B of turbocharger 18 increases as the velocity of intake air flow increases after the throttle opening becomes substantially fully opened to cause a time lag in increasing supercharging pressure by this increase in the rotation speed of turbine 18B. Electronic control unit 44 reads engine speed Ne from engine speed sensor 52 and refers to a map in which the characteristics illustrated in FIG. 4 are set to determine predetermined time 2. Then, when electronic control unit 44 determines that the average value calculation period is greater than the value obtained by subtracting predetermined time 1 from predetermined time 2, the procedure proceeds to step 7 (Yes). On the other hand, when electronic control unit 44 determines that the average value calculation period is equal to or less than the value obtained by subtracting predetermined time 1 from predetermined time 2, the procedure proceeds to step 11 (No) to calculate (update) the average value of intake air pressure based on intake air pressure P read from intake air pressure sensor 48. Here, for example, the average value of intake air pressure can be determined as an arithmetic mean, a geometric mean, a harmonic mean (an arithmetic average), or a weighted mean.

In step 7, electronic control unit 44 regards the average intake air pressure value calculated in step 11 as atmospheric pressure to estimate the atmospheric pressure.

In step 8, electronic control unit 44 sets the update flag to 1.

According to this atmospheric pressure estimation processing, when throttle opening TVO becomes equal to or greater than the predetermined opening and this state remains for predetermined time 1, it is determined that intake air pressure P in the downstream of throttle valve 22 becomes around atmospheric pressure, starting the calculation of an average value of intake air pressure P. At this time, since predetermined time 1 is changed according to engine speed Ne, the calculation of an average value of intake air pressure P can be started at a timing in consideration of a time lag in filling, with intake air, intake pipe 12 and intake collector located downstream of throttle valve 22.

Furthermore, when the time obtained by subtracting predetermined time 1 from predetermined time 2 has elapsed after the start of the calculation of an average value of intake air pressure P, it is determined that intake air pressure P in the downstream of throttle valve 22 becomes higher than atmospheric pressure as a result of supercharging, and the calculation of the average value of intake air pressure P is completed. At this time, since predetermined time 2 is changed according to engine speed Ne, the calculation of the average value of intake air pressure P can be completed at a timing in consideration of the time lag in filling, with intake air, intake pipe 12 and intake collector located downstream of throttle valve 22.

Then, as illustrated in FIG. 5, when predetermined time 1 has elapsed after throttle opening TVO is substantially fully opened, since intake air pressure P in the downstream of throttle valve 22 becomes substantially atmospheric pressure, the average value of intake air pressure P is calculated from this point in time until the time obtained by subtracting predetermined time 1 from predetermined time 2 has elapsed. Here, the reason for calculating the average value of intake air pressure P is to smooth changes in output values by using the average value in consideration of the possibility that the output value of intake air pressure sensor 48 may somewhat vary due to a disturbance and the like. After that, the average value of intake air pressure P is regarded as the atmospheric pressure, so that the atmospheric pressure can be estimated without special processing.

In other words, when throttle opening TVO becomes substantially fully open, since intake air pressure in the downstream of throttle valve 22 rises across the atmospheric pressure, intake air pressure P is detected at this timing of crossing the atmospheric pressure, so that even engine 10 with turbocharger 18 can enhance the estimation accuracy of the atmospheric pressure. If some error in the estimation accuracy of atmospheric pressure is allowed, the atmospheric pressure may be estimated from intake air pressure P detected at at least one point in the average value calculation period.

In addition, when throttle opening TVO is substantially fully opened, the update flag becomes 1 after the atmospheric pressure is estimated, and this can prevent the atmospheric pressure from being repeatedly estimated until throttle opening TVO becomes less than the predetermined opening. In other words, since predetermined times 1 and 2 are changed according to engine speed Ne, there is a repetition of satisfaction and unsatisfaction of the estimation conditions for atmospheric pressure due to changes in engine speed Ne in the substantially full-open state of throttle opening TVO. In this case, the estimation of atmospheric pressure is repeated a number of times, so that there is the risk of reduction in the estimation accuracy. However, the introduction of the update flag can suppress the reduction.

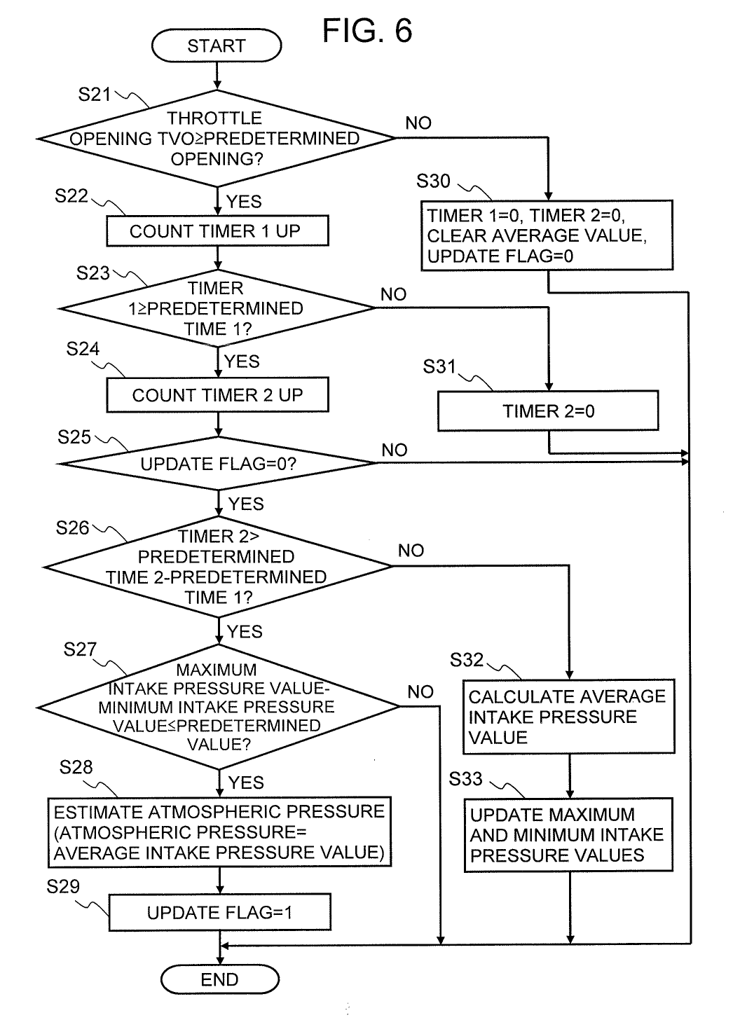

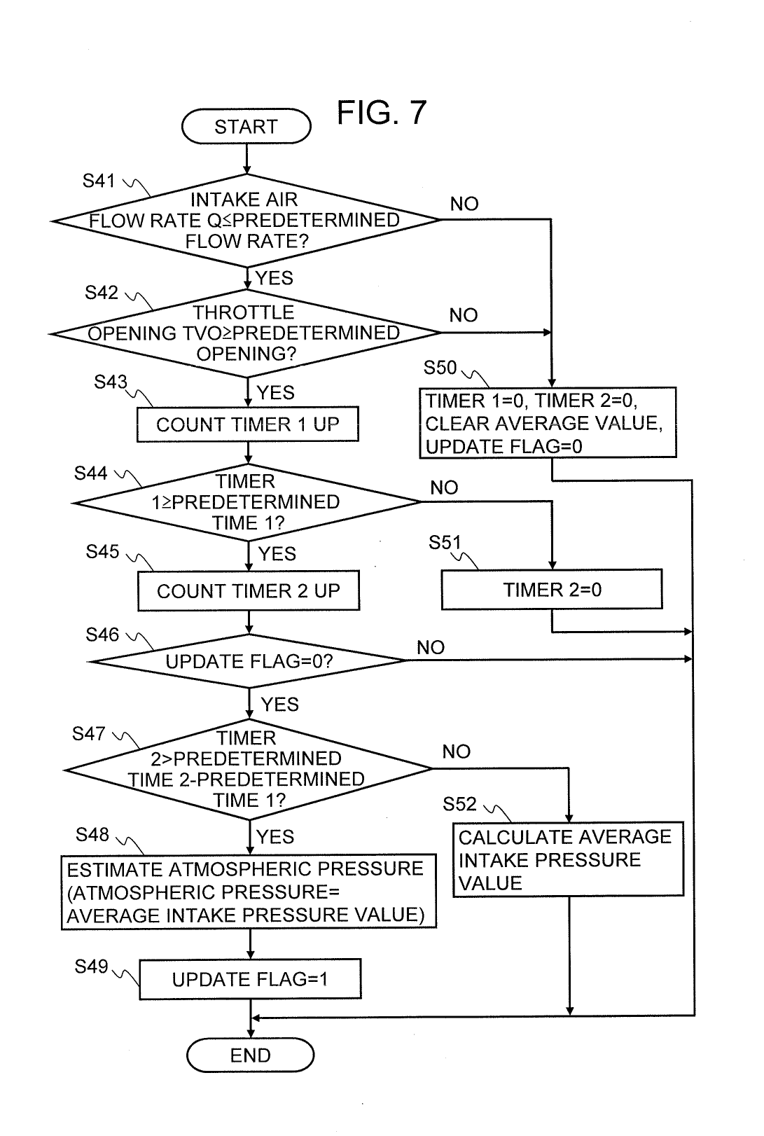

FIG. 6 illustrates a second example of atmospheric pressure estimation processing to be performed by electronic control unit 44 repeatedly at every predetermined time Δt after the start of electronic control unit 44. Note that the description of common processing with the aforementioned example will be simplified from the viewpoint of eliminating redundant description. If the need arises, see the description of the aforementioned example (the same hereinafter).

In step 21, electronic control unit 44 reads throttle opening TVO from opening sensor 46 to determine whether this is equal to or greater than a predetermined opening. Then, when electronic control unit 44 determines that throttle opening TVO is equal to or greater than the predetermined opening, the procedure proceeds to step 22 (Yes). On the other hand, when electronic control unit 44 determines that throttle opening TVO is less than the predetermined opening, the procedure proceeds to step 30 (No) to reset the counts of timer 1 and timer 2 to 0, respectively, clear the average intake air pressure value to 0, and reset the update flag to 0.

In step 22, electronic control unit 44 counts timer 1 up.

In step 23, electronic control unit 44 determines whether the duration of the substantially full-open state, obtained by multiplying the count of timer 1 by predetermined time Δt, is equal to or greater than a predetermined time 1. Then, when electronic control unit 44 determines that the duration of throttle opening TVO in the substantially full-open state is equal to or greater than predetermined time 1, the procedure proceeds to step 24 (Yes). On the other hand, when electronic control unit 44 determines that the duration of throttle opening TVO in the substantially full-open state is less than predetermined time 1, the procedure proceeds to step 31 (No) to reset the count of timer 2 to 0.

In step 24, electronic control unit 44 counts timer 2 up.

In step 25, electronic control unit 44 determines whether the update flag is 0. Then, when electronic control unit 44 determines that the update flag is 0, the procedure proceeds to step 26 (Yes), while when it determines that the update flag is 1, the processing is ended (No).

In step 26, electronic control unit 44 determines whether the average value calculation period, obtained by multiplying the count of timer 2 by predetermined time Δt, is greater than a value obtained by subtracting predetermined time 1 from predetermined time 2. Then, when electronic control unit 44 determines that the average value calculation period is greater than the value obtained by subtracting predetermined time 1 from predetermined time 2, the procedure proceeds to step 27 (Yes). On the other hand, when electronic control unit 44 determines that the average value calculation period is equal to or less than the value obtained by subtracting predetermined time 1 from predetermined time 2, the procedure proceeds to step 32 (No) to calculate the average value based on intake air pressure P read from intake air pressure sensor 48. Then, in step 33, the maximum and minimum values of intake air pressure P are updated.

In step 27, electronic control unit 44 determines whether a value obtained by subtracting the minimum intake air pressure value from the maximum intake air pressure value updated in step 33 is equal to or less than a predetermined value. Here, the predetermined value is a threshold for determining whether to estimate atmospheric pressure, for example, taking a value according to the pressure detection accuracy of intake air pressure sensor 48 in the case of no disturbance. Then, when electronic control unit 44 determines that the value obtained by subtracting the minimum intake air pressure value from the maximum intake air pressure value is equal to or less than a predetermined value, the procedure proceeds to step 28 (Yes), while when it determines that the value obtained by subtracting the minimum intake air pressure value from the maximum intake air pressure value is greater than the predetermined value, the processing is ended (No).

In step 28, electronic control unit 44 regards the average intake air pressure value calculated in step 32 as atmospheric pressure to estimate the atmospheric pressure.

In step 29, electronic control unit 44 sets the update flag to 1.

According to this atmospheric pressure estimation processing, in addition to the processing in the aforementioned first example, the maximum value and the minimum value of intake air pressure P detected in the average value calculation period are updated sequentially. Then, such a condition that the value, obtained by subtracting the minimum intake air pressure value from the maximum intake air pressure value, is equal to or less than the predetermined value, i.e., such a condition that the variation range of intake air pressure P is equal to or less than the predetermined value, is imposed as a condition for estimating atmospheric pressure. Therefore, when a significant error due to a disturbance and the like is included in sensor output, the estimation of atmospheric pressure is prohibited. This can further enhance the estimation accuracy of atmospheric pressure. Since the other operations and effects are shared with the aforementioned first example, the description thereof will be omitted (the same will be applied hereinafter).

Instead of processing step 27, such conditions that a value, obtained by subtracting the average intake air pressure value from the maximum intake air pressure value, is equal to or less than a first predetermined value, and that a value, obtained by subtracting the minimum intake air pressure value from the average intake air pressure value, is equal to or less than a second predetermined value may be adopted as conditions for estimating atmospheric pressure. In this case, when the maximum value and the minimum value fall within predetermined ranges, respectively, with respect to the average intake air pressure value, atmospheric pressure is estimated. This can suppress reduction in estimation accuracy due to a disturbance and the like. Here, the first predetermined value and the second predetermined value may be the same or different from each other.

FIG. 7 illustrates a third example of atmospheric pressure estimation processing to be performed by electronic control unit 44 repeatedly at every predetermined time Δt after the start of electronic control unit 44.

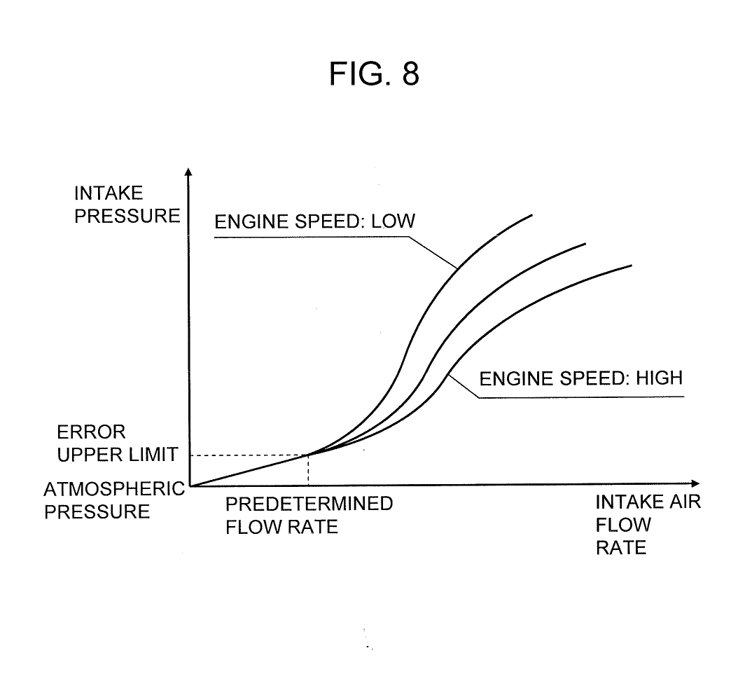

In step 41, electronic control unit 44 reads intake air flow Q from intake air flow sensor 16 to determine whether this is equal to or less than a predetermined flow rate. Here, the predetermined flow rate is a threshold for determining whether turbocharger 18 is performing supercharging, the value of which is determined accordingly from a correlation among intake air flow, engine speed, and intake air pressure, for example, as illustrated in FIG. 8. In other words, in a case in which the engine speed is maintained constant, when the intake air flow exceeds a certain point (predetermined flow rate), the intake air pressure will increase sharply as the intake air flow increases. Since it is considered that turbocharger 18 is performing supercharging in such a range that the intake air pressure sharply increases, atmospheric pressure can be estimated before the range to thereby secure the estimation accuracy of the atmospheric pressure. Then, when electronic control unit 44 determines that intake air flow Q is equal to or less than the predetermined flow rate, the procedure proceeds to step 42 (Yes). On the other hand, when electronic control unit 44 determines that intake air flow Q is greater than the predetermined flow rate, the procedure proceeds to step 50 (No) to reset the counts of timer 1 and timer 2 to 0, respectively, clear the average intake air pressure value to 0, and reset the update flag to 0. Note that the predetermined flow rate may be changed according to the engine speed.

In step 42, electronic control unit 44 reads throttle opening TVO from opening sensor 46 to determine whether this is equal to or greater than a predetermined opening. Then, when electronic control unit 44 determines that throttle opening TVO is equal to or greater than the predetermined opening, the procedure proceeds to step 43 (Yes), whereas when it determines that throttle opening TVO is less than the predetermined opening, the procedure proceeds to step 50 (No).

In step 43, electronic control unit 44 counts timer 1 up.

In step 44, electronic control unit 44 determines whether the duration of the substantially full-open state, obtained by multiplying the count of timer 1 by predetermined time Δt, is equal to or greater than a predetermined time 1. Then, when electronic control unit 44 determines that the duration of throttle opening TVO in the substantially full-open state is equal to or greater than predetermined time 1, the procedure proceeds to step 45 (Yes). On the other hand, when electronic control unit 44 determines that the duration of throttle opening TVO in the substantially full-open state is less than predetermined time 1, the procedure proceeds to step 51 (No) to reset the count of timer 2 to 0.

In step 45, electronic control unit 44 counts timer 2 up.

In step 46, electronic control unit 44 determines whether the update flag is 0. Then, when electronic control unit 44 determines that the update flag is 0, the procedure proceeds to step 47 (Yes), whereas when it determines that the update flag is 1, the processing is ended (No).

In step 47, electronic control unit 44 determines whether the average value calculation period, obtained by multiplying the count of timer 2 by predetermined time Δt, is greater than a value obtained by subtracting predetermined time 1 from predetermined time 2. Then, when electronic control unit 44 determines that the average value calculation period is greater than the value obtained by subtracting predetermined time 1 from predetermined time 2, the procedure proceeds to step 48 (Yes). On the other hand, when electronic control unit 44 determines that the average value calculation period is equal to or less than the value obtained by subtracting predetermined time 1 from predetermined time 2, the procedure proceeds to step 52 (No) to calculate the average intake air pressure value based on intake air pressure P read from intake air pressure sensor 48.

In step 48, electronic control unit 44 regards the average intake air pressure value calculated in step 52 as atmospheric pressure to estimate the atmospheric pressure.

In step 49, electronic control unit 44 sets the update flag to 1.

According to this atmospheric pressure estimation processing, in addition to the processing in the aforementioned first example, such a condition that intake air flow Q is equal to or less than the predetermined flow rate is imposed as a condition for estimating atmospheric pressure. In other words, when intake air flow Q is greater than the predetermined flow rate, since there is a possibility that intake air pressure in the upstream of throttle valve 22 rises greater than intake air pressure in the downstream thereof due to supercharging by turbocharger 18, the estimation of atmospheric pressure in this state is prohibited, so that the estimation accuracy of atmospheric pressure can further be enhanced.

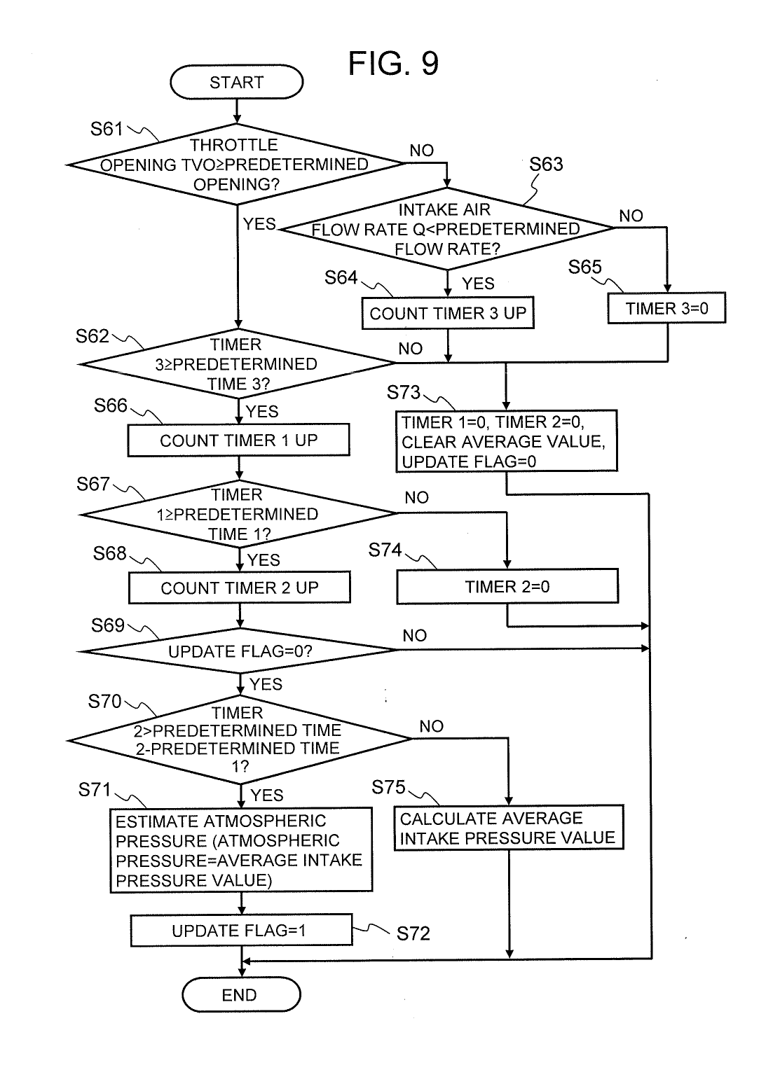

FIG. 9 illustrates a fourth example of atmospheric pressure estimation processing to be performed by electronic control unit 44 repeatedly at every predetermined time Δt after the start of electronic control unit 44.

In step 61, electronic control unit 44 reads throttle opening TVO from opening sensor 46 to determine whether this is equal to or greater than a predetermined opening. Then, when electronic control unit 44 determines that throttle opening TVO is equal to or greater than the predetermined opening, the procedure proceeds to step 62 (Yes), whereas when it determines that throttle opening TVO is less than the predetermined opening, the procedure proceeds to step 63 (No).

In step 62, electronic control unit 44 determines whether the duration of such a state that an intake air flow, obtained by multiplying the count of a timer 3 by a predetermined time Δt, is less than a predetermined flow rate becomes equal to or greater than predetermined time 3. Here, predetermined time 3 is a threshold for determining whether supercharging remains due to the inertial rotation of turbine 18B of turbocharger 18, the value of which is set, for example, in consideration of the characteristics of turbocharger 18. Then, when electronic control unit 44 determines that the duration of the intake air flow in the state of being less than the predetermined flow rate is equal to or greater than predetermined time 3, the procedure proceeds to step 66 (Yes). On the other hand, when electronic control unit 44 determines that the duration of the intake air flow in the state of being less than the predetermined flow rate is less than predetermined time 3, the procedure proceeds to step 73 (No) to reset the counts of timer 1 and timer 2 to 0, respectively, clear the average intake air pressure value to 0, and reset the update flag to 0.

In step 63, electronic control unit 44 reads intake air flow Q from intake air flow sensor 16 to determine whether this is less than the predetermined flow rate. Then, when electronic control unit 44 determines that intake air flow Q is less than the predetermined flow rate, the procedure proceeds to step 64 (Yes) to count timer 3 up, i.e., it moves the duration of the state, in which intake air flow Q is less than the predetermined flow rate, forward by predetermined time Δt. After that, the procedure proceeds to step 73. On the other hand, when electronic control unit 44 determines that intake air flow Q is equal to or greater than the predetermined flow rate, the procedure proceeds to step 65 (No) to rest the count of timer 3 to 0. After that, the procedure proceeds to step 73.

In step 66, electronic control unit 44 counts timer 1 up.

In step 67, electronic control unit 44 determines whether the duration of the substantially full-open state, obtained by multiplying the count of timer 1 by predetermined time Δt, becomes equal to or greater than predetermined time 1. Then, when electronic control unit 44 determines that the duration of throttle opening TVO in the substantially full-open state becomes equal to or greater than predetermined time 1, the procedure proceeds to step 68 (Yes). On the other hand, when electronic control unit 44 determines that the duration of throttle opening TVO in the substantially full-open state is less than predetermined time 1, the procedure proceeds to step 74 (No) to reset the count of timer 2 to 0.

In step 68, electronic control unit 44 counts timer 2 up.

In step 69, electronic control unit 44 determines whether the update flag is 0. Then, when electronic control unit 44 determines that the update flag is 0, the procedure proceeds to step 70 (Yes), whereas when it determines that the update flag is 1, the processing is ended (No).

In step 70, electronic control unit 44 determines whether the average value calculation period, obtained by multiplying the count of timer 2 by predetermined time Δt, is greater than a value obtained by subtracting predetermined time 1 from predetermined time 2. Then, when electronic control unit 44 determines that the average value calculation period is greater than the value obtained by subtracting predetermined time 1 from predetermined time 2, the procedure proceeds to step 71 (Yes). On the other hand, when electronic control unit 44 determines that the average value calculation period is equal to or less than the value obtained by subtracting predetermined time 1 from predetermined time 2, the procedure proceeds to step 75 (No) to calculate the average intake air pressure value based on intake air pressure P read from intake air pressure sensor 48.

In step 71, electronic control unit 44 regards the average intake air pressure value calculated in step 75 as atmospheric pressure to estimate the atmospheric pressure.

In step 72, electronic control unit 44 sets the update flag to 1.

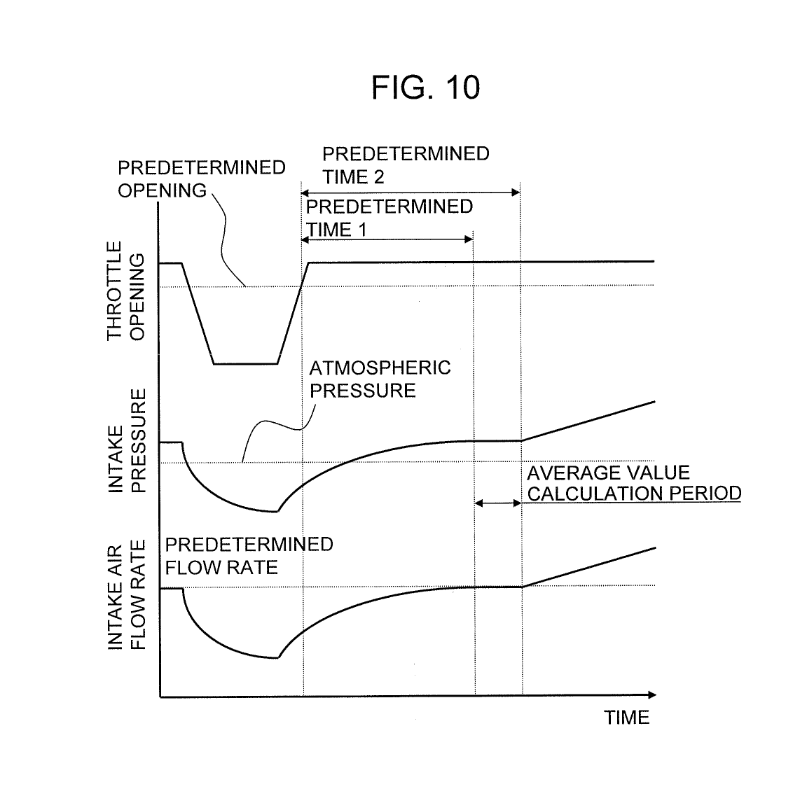

According to this atmospheric pressure estimation processing, in addition to the processing in the aforementioned first example, such a condition that intake air flow Q is less than the predetermined flow rate remains for predetermined time 3 is imposed as a condition for estimating atmospheric pressure. In other words, for example, when throttle opening TVO is fully opened after being closed for a moment as illustrated in FIG. 10, since supercharging remains due to the inertial rotation of turbine 18B of turbocharger 18, there is a possibility that intake air pressure in the upstream of throttle valve 22 will be around atmospheric pressure. In this case, intake air pressure becomes higher than the atmospheric pressure at a point earlier than the beginning of the average value calculation period. Therefore, the condition is further imposed to prohibit the estimation of atmospheric pressure in the state in which supercharging by turbocharger 18 remains in order to suppress reduction in the estimation accuracy.

Instead of (or in addition to) the condition that such a state that intake air flow Q is less than the predetermined flow rate remains for predetermined time 3, such a condition that a state in which intake air pressure P or throttle opening TVO is less than the predetermined value remains for a predetermined time may be imposed as a condition for estimating atmospheric pressure.

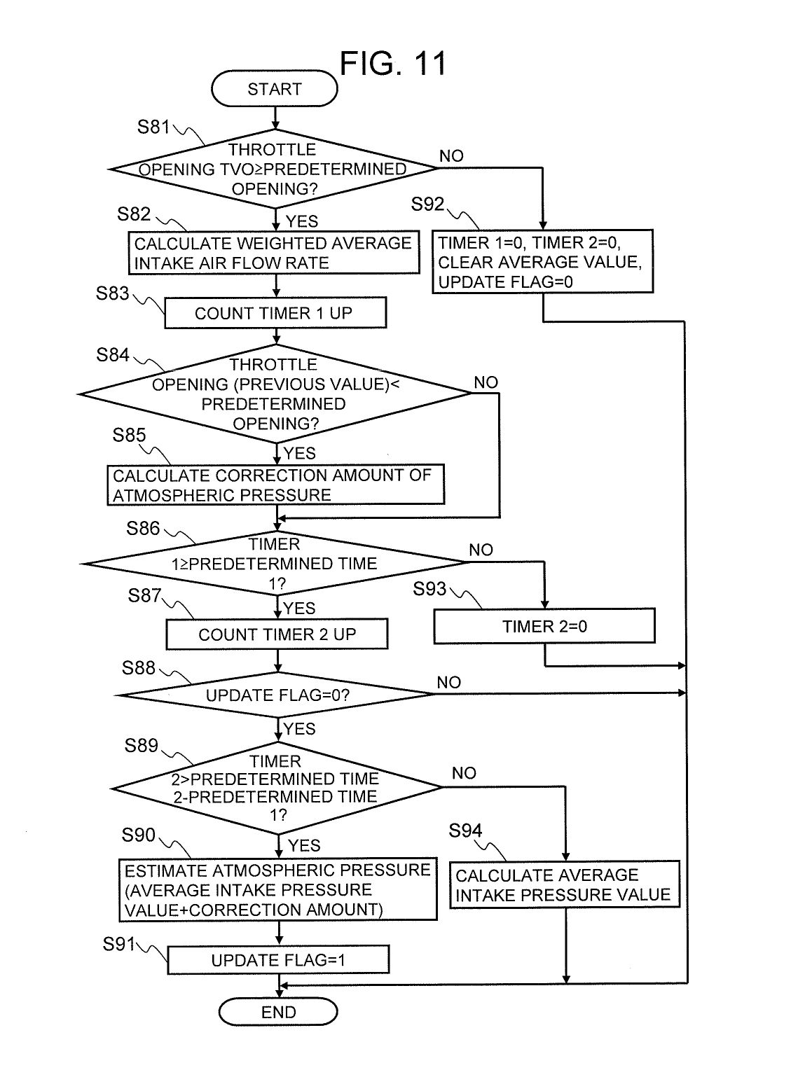

FIG. 11 illustrates a fifth example of atmospheric pressure estimation processing to be performed by electronic control unit 44 repeatedly at every predetermined time Δt after the start of electronic control unit 44.

In step 81, electronic control unit 44 reads throttle opening TVO from opening sensor 46 to determine whether this is equal to or greater than a predetermined opening. Then, when electronic control unit 44 determines that throttle opening TVO is equal to or greater than the predetermined opening, the procedure proceeds to step 82 (Yes). On the other hand, when electronic control unit 44 determines that throttle opening TVO is less than the predetermined opening, the procedure proceeds to step 92 (No) to reset the counts of timer 1 and timer 2 to 0, respectively, clear the average intake air pressure value to 0, and reset the update flag to 0.

In step 82, electronic control unit 44 reads intake air flow Q from intake air flow sensor 16 to calculate a weighted average intake air flow based on a predetermined weight.

In step 83, electronic control unit 44 counts timer 1 up.

In step 84, electronic control unit 44 determines whether throttle opening TVO in the previous processing is less than a predetermined opening. Then, when electronic control unit 44 determines that throttle opening TVO in the previous processing is less than the predetermined opening, the procedure proceeds to step 85 (Yes), whereas when it determines that throttle opening TVO in the previous processing is equal to or greater than the predetermined opening, the procedure proceeds to step 86 (No).

In step 85, electronic control unit 44 refers to a map in which the amount of correction of atmospheric pressure according to the intake air flow is set to calculate the amount of correction of atmospheric pressure according to the weighted average value of intake air flow at a point at which throttle opening TVO comes into the substantially full-open state.

In step 86, electronic control unit 44 determines whether the duration of the substantially full-open state, obtained by multiplying the count of timer 1 by predetermined time Δt, becomes equal to or greater than predetermined time 1. Then, when electronic control unit 44 determines that the duration of throttle opening TVO in the substantially full-open state becomes equal to or greater than predetermined time 1, the procedure proceeds to step 87 (Yes). On the other hand, when electronic control unit 44 determines that the duration of throttle opening TVO in the substantially full-open state is less than predetermined time 1, the procedure proceeds to step 93 (No) to reset the count of timer 2 to 0.

In step 87, electronic control unit 44 counts timer 2 up.

In step 88, electronic control unit 44 determines whether the update flag is 0. Then, when electronic control unit 44 determines that the update flag is 0, the procedure proceeds to step 89 (Yes), whereas when it determines that the update flag is 1, the processing is ended (No).

In step 89, electronic control unit 44 determines whether the average value calculation period, obtained by multiplying the count of timer 2 by predetermined time Δt, is greater than a value obtained by subtracting predetermined time 1 from predetermined time 2. Then, when electronic control unit 44 determines that the average value calculation period is greater than the value obtained by subtracting predetermined time 1 from predetermined time 2, the procedure proceeds to step 90 (Yes). On the other hand, when electronic control unit 44 determines that the average value calculation period is equal to or less than the value obtained by subtracting predetermined time 1 from predetermined time 2, the procedure proceeds to step 94 (No) to calculate the average intake air pressure value based on intake air pressure P read from intake air pressure sensor 48.

In step 90, electronic control unit 44 adds the amount of correction of atmospheric pressure to the average intake air pressure value calculated in step 94 to estimate the atmospheric pressure.

In step 91, electronic control unit 44 sets the update flag to 1.

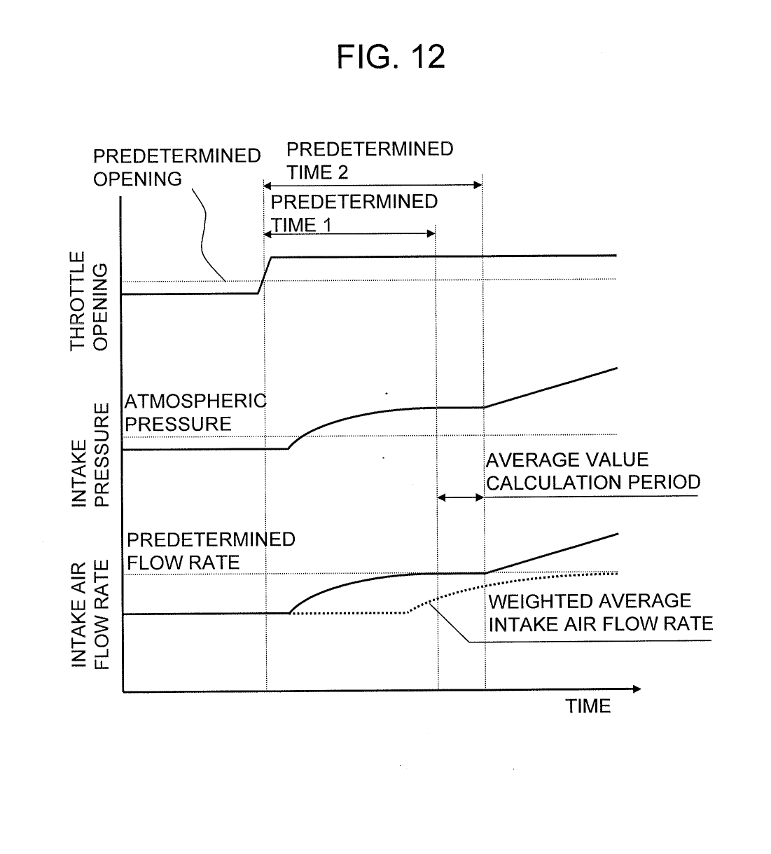

According to this atmospheric pressure estimation processing, in addition to the processing in the aforementioned first example, the average intake air pressure value calculated in the average value calculation period is corrected based on the weighted average intake air flow when the throttle opening comes into the substantially fully-open state. In other words, when the throttle opening is substantially fully opened from a weakly supercharged state, the throttle opening comes into the substantially full-open state just by opening the throttle opening a little as illustrated in FIG. 12. In this case, since intake air pressure exceeds the atmospheric pressure in a short time, it is considered that the estimation of the atmospheric pressure is prohibited. However, if the estimation of the atmospheric pressure is prohibited, the estimation frequency will be decreased. Therefore, in view of the fact that the rotation of turbine 18B of turbocharger 18 increases as the intake air flow increases to increase intake air pressure in the upstream of throttle valve 22, the average intake air pressure value is corrected based on the weighted average intake air flow to further enhance the estimation accuracy of the atmospheric pressure while suppressing the decrease in the estimation frequency of the atmospheric pressure.

In the first to fifth examples described above, when the substantially full-open state of throttle opening TVO remains for predetermined time 1, timekeeping of the average value calculation period is started, but timekeeping of the average value calculation period may be started when throttle opening TVO comes into the substantially fully-open state. Furthermore, the substantially fully-open state of throttle opening TVO and the average value calculation period may also be timed directly by using a clock function incorporated in the microcomputer, rather than through the counts of timer 1 and timer 2. In addition, some of the points described in each example may be replaced or combined appropriately.

The entire contents of Japanese Patent Application No. 2012-058594, filed Mar. 15, 2012, are incorporated herein by reference.

While only a select embodiment has been chosen to illustrate the present invention, it will be apparent to those skilled in the art from this disclosure that various change and modification can be made herein without departing from the scope of the invention as defined in the appended claims.

Furthermore, the foregoing descriptions of the embodiments according to the present invention are provided for illustration only, and not for the purpose of limiting the invention, the invention as claimed in the appended claims and their equivalents.

What is claimed is:

1. An engine control unit comprising:
an intake air pressure sensor for detecting intake air pressure in a downstream of a throttle valve provided in an intake system of an engine with a supercharger; and
an electronic control unit which, when an opening of the throttle valve is substantially fully opened, estimates atmospheric pressure based on the intake air pressure at a time of start of supercharging by the supercharger.

2. The engine control unit according to claim 1, wherein the electronic control unit sets the time of start of supercharging by the supercharger based on an engine speed of the engine.

3. The engine control unit according to claim 1, wherein the supercharger is a turbocharger.

4. The engine control unit according to claim 1, wherein the electronic control unit estimates atmospheric pressure based on an average value of the intake air pressure from a point in time when the intake air pressure comes close to atmospheric pressure to a point in time when the intake air pressure becomes equal to or greater than atmospheric pressure as a result of supercharging.

5. The engine control unit according to claim 4, wherein the electronic control unit regards the average value of the intake air pressure as atmospheric pressure to estimate atmospheric pressure.

6. The engine control unit according to claim 1, wherein when a variation in the intake air pressure from a point in time when the intake air pressure comes close to atmospheric pressure to a point in time when the intake air pressure becomes equal to or greater than atmospheric pressure as a result of supercharging is equal to or less than a predetermined value, the electronic control unit estimates atmospheric pressure.

7. The engine control unit according to claim 1, further comprising
an intake air flow sensor for detecting a flow rate of intake air flowing through the intake system,
wherein when the flow rate of intake air is equal to or less than a predetermined flow rate, the electronic control unit estimates atmospheric pressure.

8. The engine control unit according to claim 1, further comprising
an intake air flow sensor for detecting a flow rate of intake air flowing through the intake system,
wherein when such a state that a flow rate of intake air is less than a predetermined flow rate remains for a predetermined time before the opening of the throttle valve is substantially fully opened, the electronic control unit estimates atmospheric pressure.

9. The engine control unit according to claim 1, further comprising
an intake air flow sensor for detecting a flow rate of intake air flowing through the intake system,
wherein the electronic control unit corrects the atmospheric pressure based on a weighted average of the intake air flow when the opening of the throttle valve is substantially fully opened.

10. An atmospheric pressure estimation method, wherein
when an opening of a throttle valve provided in an intake system of an engine with a supercharger is substantially fully opened, an electronic control unit with a built-in microcomputer estimates atmospheric pressure based on intake air pressure in a downstream of the throttle valve at a time of start of supercharging by the supercharger.

11. The atmospheric pressure estimation method according to claim 10, wherein the electronic control unit sets the time of start of supercharging by the supercharger based on an engine speed of the engine.

12. The atmospheric pressure estimation method according to claim 10, wherein the supercharger is a turbocharger.

13. The atmospheric pressure estimation method according to claim 10, wherein the electronic control unit estimates atmospheric pressure based on an average value of the intake air pressure from a point in time when the intake air pressure comes close to atmospheric pressure to a point in time when the intake air pressure becomes equal to or greater than atmospheric pressure as a result of supercharging.

14. The atmospheric pressure estimation method according to claim 13, wherein the electronic control unit regards the average value of the intake air pressure as atmospheric pressure to estimate atmospheric pressure.

15. The atmospheric pressure estimation method according to claim 10, wherein when a variation range of the intake air pressure from a point in time when the intake air pressure comes close to atmospheric pressure to a point in time when the intake air pressure becomes equal to or greater than atmospheric pressure as a result of supercharging is equal to or less than a predetermined value, the electronic control unit estimates atmospheric pressure.

16. The atmospheric pressure estimation method according to claim 10, wherein when a flow rate of intake air flowing through the intake system is equal to or less than a predetermined flow rate, the electronic control unit estimates atmospheric pressure.

17. The atmospheric pressure estimation method according to claim 10, wherein when such a state that a flow rate of intake air flowing through the intake system is less than a predetermined flow rate remains for a predetermined time before the opening of the throttle valve is substantially fully opened, the electronic control unit estimates atmospheric pressure.

18. The atmospheric pressure estimation method according to claim 10, wherein the electronic control unit corrects the atmospheric pressure based on a weighted average of an intake air flow when the opening of the throttle valve is substantially fully opened.
